(19) United States
(12) Patent Application Publication
(10) Pub. No.: US 2026/0220151 A1
(43) Pub. Date: Jul. 30, 2026

(54) GENERATING FORMATTING AND FIT ENGINES FOR DATA SAMPLES

(71) Applicant: International Business Machines Corporation, Armonk, NY (US)

(72) Inventors: Shabana Baig, Burlington, MA (US); Nadiya Kochura, Bolton, MA (US); Pakhi Gupta, Cambridge, MA (US); Brajesh Pandey, Shrewsbury, MA (US); Rebecca Bonne-Annee, San Antonio, TX (US)

(21) Appl. No.: 19/038,464

(22) Filed: Jan. 27, 2025

(51) Int. Cl. G06F 16/25

(52) U.S. Cl. CPC G06F 16/258

(57) ABSTRACT

A method, according to one approach, includes: obtaining table statistics and a table format of a source table. The method also includes obtaining user profile information associated with a first user. A trained AI-based model is used to evaluate the table statistics, table format, and user profile information. The trained AI-based model is also used to generate a preferred table format and fit engine for data received from the first user. A table for the data received from the first user is further generated based at least in part on the preferred table format and fit engine generated by the AI-based model.

### BACKGROUND

The present invention relates to data analysis, and more specifically, this invention relates to efficiently accessing formatted data.

Data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does overhead associated with processing the data. This is particularly true for unstructured data which is not analyzed using conventional data tools and methods. For instance, unstructured data is not formatted. While unformatted data is more versatile in terms of how it is evaluated, the process of analyzing the data is complicated and cumbersome. Moreover, specialized tools are used to manipulate the unstructured data.

### SUMMARY

A method, according to one approach, includes: obtaining table statistics and a table format of a source table. The method also includes obtaining user profile information associated with a first user. A trained AI-based model is used to evaluate the table statistics, table format, and user profile information. The trained AI-based model is also used to generate a preferred table format and fit engine for data received from the first user. A table for the data received from the first user is further generated based at least in part on the preferred table format and fit engine generated by the AI-based model.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2A is a representational view of a distributed system, in accordance with one approach.

FIG. 2B is a partial detailed view of processors and/or AI modules, in accordance with one approach.

FIG. 3A is a flowchart of a method, in accordance with one approach.

FIG. 3B is a representational view of pseudo code, in accordance with one approach.

FIG. 4 is a representational view of a data management module, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for dynamically analyzing source data in light of a number of different contexts, and generating preferred formatting information that achieves high performance during query planning and execution in management platforms such as Lakehouse systems. Approaches herein are also desirably able to generate a preferred fit engine that is configured to process the source data in a most efficient manner. The formatting information and/or fit engine are generated using outputs produced by AI-based models that are trained (and re-trained over time) to evaluate data and develop a rich insight into how the data should be stored to ensure the efficient use thereof, e.g., as will be described in further detail below.

In one general approach, a method includes: obtaining table statistics and a table format of a source table. The method also includes obtaining user profile information associated with a first user. A trained AI-based model is used to evaluate the table statistics, table format, and user profile information. The trained AI-based model is also used to generate a preferred table format and fit engine for data received from the first user. A table for the data received from the first user is further generated based at least in part on the preferred table format and fit engine generated by the AI-based model.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as new data processing code in block 150 for dynamically analyzing source data in light of a number of different contexts, and generating preferred formatting information that achieves high performance during query planning and execution in management platforms such as Lakehouse systems. Approaches herein are also desirably able to generate a preferred fit engine that is configured to process the source data in a most efficient manner. The formatting information and/or fit engine are generated using outputs produced by AI-based models that are trained (and re-trained over time) to evaluate data and develop a rich insight into how the data should be stored to ensure the efficient use thereof, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

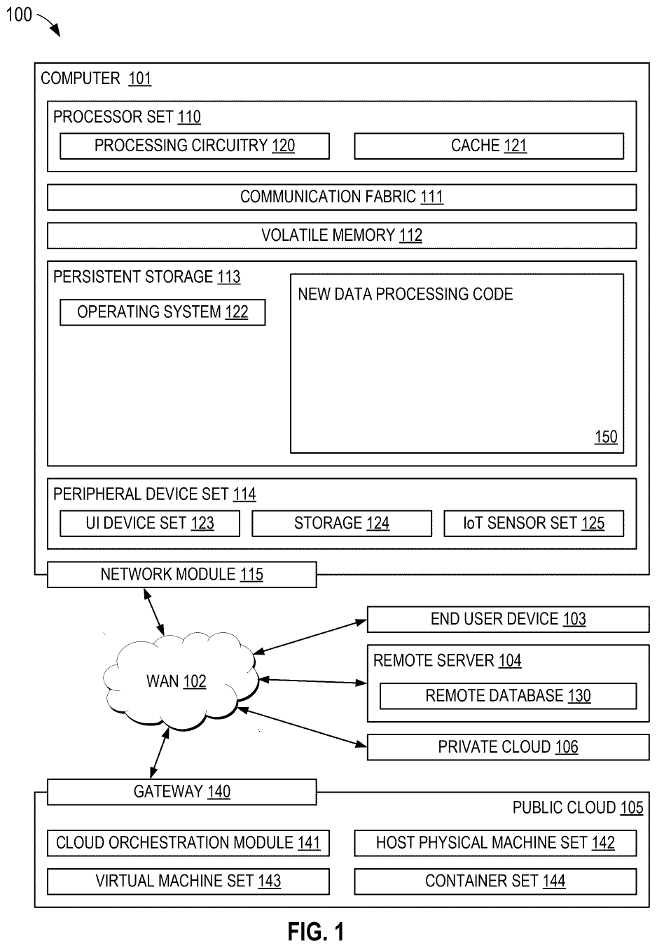

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices.

Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, with the boom in machine learning and related fields, the amount and variety of data generated and stored has increased exponentially. Most of the generated data is completely unstructured and can range from text to digital content.

Deriving any insights from these unstructured data sources (also referred to as “data lakes”) presents numerous challenges. For instance, traditional data warehouses do not support unstructured data and tightly-couple compute and storage which leads to high cost when dealing with monolithic data. Similarly, conventional cloud warehouses with data lakes also present challenges in terms of data governance and data quality. While using decoupled compute and cheaper storage has helped with the ownership costs, the extract, transform and load (ETL) operations are more complex, causing data staleness and quality to be of significant concern for conventional products.

Traditional database engines use proprietary storage formats and were designed for specific workloads. However, with the wide adoption of open formats, traditional data management platforms face challenges with satisfying different queriers without impacting performance. For instance, performance of a query execution depends on the type of query, statistics, use-case, engine performance tuning parameters, and open table format.

It follows that the amount and/or type of information that is provided by the metadata layer of a Lakehouse system has at least some impact on performance. For instance, the speed at which metadata can be retrieved and utilized impacts performance of a query execution and metadata processing time heavily depends on the type of table format that was used to store the metadata.

Approaches herein thereby adopt a new Lakehouse data management architecture which implements data governance on top of unstructured data lakes. Lakehouse systems are thereby able to use open file formats such as APACHE PARQUET to store data files and table formats such as APACHE ICEBERG to manage table metadata. The Lakehouse architecture also addresses several challenges that existing data warehouses have faced, thereby improving data quality, data staleness, costs, vendor lock-in, and limited use-case support. Additionally, a Lakehouse system may support colocation features, such as partitioning, compaction, and fan-in writes.

Lakehouse systems use open formats which make it possible for different types of data engines to share and access data residing in various data lakes. However, the performance of queries in such systems depends on the type of query, statistics, use-case, data engine performance tuning parameters, open table format information, etc. It follows that planning a query in a Lakehouse system involves evaluating real-time information (e.g., data file locations, table statistics, performance metrics, user preferences, etc.), and determining a table format as well as a data engine configuration to use while processing data lakes.

For example, some table formats provide a metadata layer in the Lakehouse architecture which allows data warehouse features, e.g., such as Atomicity, Consistency, Isolation, and Durability (ACID) transactions, query optimization, “time travel”, etc. These rich metadata layers make it possible for data engines to share and access data residing in the data lakes, e.g., as would be appreciated by one skilled in the art after reading the present description.

According to a non-limiting example, APACHE HUDI stores metadata as a separate table based on HFile base file format. Metadata is read based on indexed lookups. Additionally, the metadata table stores a list all physical file paths that are part of a table. HUDI provides snapshot isolation between writers and readers which allows data engines to plan queries in a distributed fashion. However, these configurations differ from other table formats and data engine configurations. According to another example, APACHE ICEBERG maintains a table's metadata as a list of files in a hierarchical manner. Accordingly, the upper level of files acts as an index for the next level of files. A data engine may parse the metadata structure sequentially while planning a query over a corresponding table. In still another example, DELTA LAKE stores metadata of a table in tabular format, and the metadata can be tracked using log checkpoints and/or delta log files. It follows that received data may be evaluated differently, allowing for different types of received data to be processed efficiently regardless of the system configuration and/or amount of data that is received.

Again, Lakehouse systems use open formats which make it possible for data engines having different configurations to share and access data residing in the data lakes. However, this also leads to significant swings in performance depending on the open table format used when querying metadata.

The process of choosing table formats and/or data engine configurations to apply to different data without negatively impacting performance is a complex process that is constantly changing over time. For example, performance of a query execution depends on the type of query, statistics, use-case, engine performance tuning parameters, open table formats, etc. Approaches herein thereby underscore the importance of having a rich source (e.g., metadata layer) of statistics corresponding to data residing in data lakes. Again, the speed at which the metadata can be retrieved and utilized governs performance of query execution. Moreover, metadata processing time heavily depends on the type of table format that was used to store the metadata. The approaches herein thereby have a significant impact on efficiency of the system overall, e.g., as will be described in further detail below.

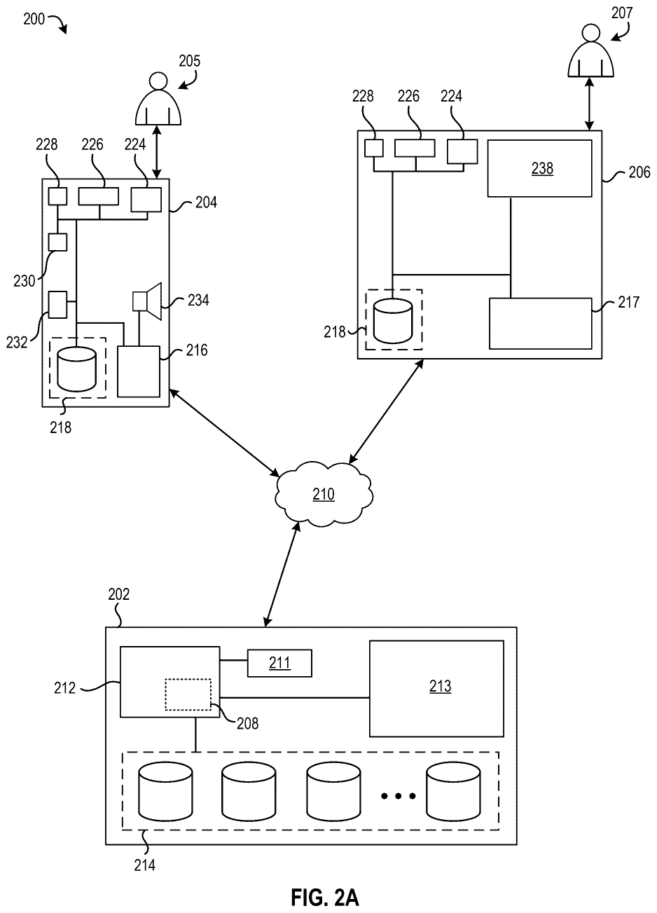

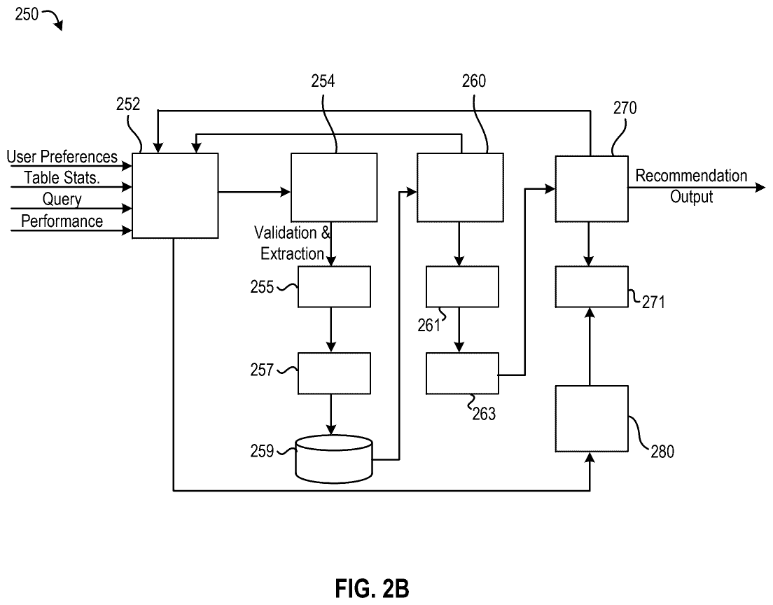

Looking now to FIG. 2A, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2A (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc. ; etc., or any other type of connection which would be apparent to one skilled in the art after reading the present description.

The terms “user” and “administrator” are in no way intended to be limiting either. For instance, while users and clients may be described as being individuals in various implementations herein, a user and/or client may be an application, an organization, a preset process, etc. The use of “data” and “information” herein is in no way intended to be limiting either, and may include any desired type of details, e.g., depending on the type of operating system implemented on the user device 204, edge node 206, and/or central server 202. For example, video data, audio data, sensor data, metadata, outputs produced by AI-based models, images, etc. may be sent to the central server 202 from user device 204 and/or edge node 206 for processing using one or more AI-based models, e.g., such as a foundation model and/or machine learning models.

With continued reference to FIG. 2A, the central server 202 includes a large (e.g., robust) processor 212 coupled to a cache 211, an AI module 213, and a data storage array 214 having a relatively high storage capacity. As noted above, the AI module 213 may include any desired number and/or type of AI-based models (e.g., machine learning models). In preferred approaches, the AI module 213 and/or processor 212 includes one or more AI-based models that have been trained to dynamically analyzing source data including unstructured source data-in light of a number of different contexts (e.g., such as user preferences), and generating preferred formatting information that achieves high performance during query planning and execution in management platforms, e.g., such as Lakehouse systems. The AI-based models are also preferably able to generate preferred engine configurations or “fit engines” that are able to process the source data most efficiently, based at least in part on the analyzed source data and relative context.

As noted above, analyzing large amounts of data, particularly unstructured data, is a difficult and taxing process, even in situations where specialized tools are available. As a result, conventional products have been unable to provide reliable analysis of unstructured data. In contrast, machine learning module 213 and/or processor 212 may be able to analyze unstructured data and generate table (e.g., formatting) information which can be used to organize the data in a most efficient manner, along with a fit engine that is configured to access the data stored according to the generated table information. In other words, the AI-based models herein are desirably able to generate a most efficient way to organize data of varying type, size, security protocols, user standards, etc., along with a corresponding fit engine that is tailored to access (e.g., read, write to, copy, etc.) data stored according to the generated table information. For instance, the machine learning module 213 may include AI-based models that are trained to identify trends and/or common patterns in the data. These identified trends and/or patterns may further be used to organize and/or structure the source data such that generated fit engines can access the data more efficiently (e.g., with lower latency times) than conventionally achievable, particularly across wide ranges of data types and/or sizes.

Depending on the approach, the AI-based models used herein may include one or more regression models that can be applied to solve a problem. For example, linear, support vector regression, decision tree regression, etc. may be generated and trained to evaluate data and determine a most efficient manner in which to store and/or access the data using any of the approaches herein. For example, neural networks are able to model non-linear relationships between inputs and outputs. This means that neural networks can capture more complex patterns and relationships in data, which can lead to better predictions and classifications. Additionally, neural networks can be trained on large amounts of data, which can improve their accuracy and performance.

Approaches herein may use machine learning to train prediction models to predict the query cost in response to the query being executed using different query engines. Thus, by generating and applying a prediction model, approaches herein are able to determine a most efficient way to store and access data. In some approaches, a machine learning model is formed as a neural network that includes the neural network model parameters, the input layer with “N” nodes, the one or more hidden layers, and the output layer. A machine learning service generates the neural network model input features: vectors “X” that are input to the input layer, processed by the hidden layers, and then processed by the output layer to generate the output vectors “Y”.

Some approaches herein specify and define the machine learning model and its behavior. The parameters may include a definition of the machine learning model that identifies the number of nodes, layers, and connections in the neural network formed by the machine learning model as well as the activation functions, hyperparameters, batch size, bias, etc. For example, a list of hyperparameters may include, but are in no way limited to: units (number of neurons/nodes in the layer), input_dim (number of predictors in the input data which is expected by the first layer), kernel_initializer (initial values for weights), activation (the activation function for the calculations inside each neuron), batch_size (how many rows will be passed to the Network in parallel), epochs (number of epochs), total number of hidden layers, etc.

In some approaches, the input layer includes N nodes one for each of the neural network model features identified in a table. In the table, the feature values for input matrix “X” may be collected from a table format's metadata files, log files, checkpoints, the query plan, etc. Moreover, the target vector Y [ ] holds query cost values that can be extracted from the query plan. Accordingly, the system may use parsers to process the query plan and extract relevant information such as query cost. The input layer includes “N” nodes one for each of the neural network model features identified a table.

It follows that generating formatting information and corresponding fit engines to access data allows users to structure data according to themes and makes the data searchable. In some approaches, different types of formatting may also be used to identify specific portions of the data. For instance, workflow tags, journey tags, sentiment tags, general tags, etc., or any other desired type of tag may be used to characterize different types of data that are analyzed. In some approaches, predetermined tags may be established by users, e.g., based on anticipated workloads, user preferences, types of data being received, etc. In other approaches, inductive tags may be generated dynamically based on the data that is received. According to one example, the “formatting information” referred to herein includes table formatting information that is associated with the metadata layer and/or other information used to identify tables in Lakehouse systems, e.g., as would be appreciated by one skilled in the art after reading the present description.

The AI-based models may further be configured to modify the formatting information and/or fit engines, before converting at least a copy of the modified formatting information, formatted information, and/or corresponding fit engines into a predetermined exportable format, e.g., such as any desired format (e.g., .pdf, .csv, etc.), style, language, etc. Accordingly, the machine learning module 213 may be used to evaluate and categorize sets of data received from the user device 204 and/or edge node 206. In some approaches, data is converted from one table format to another by creating a new metadata layer and other storage related changes with respect to the target table format, e.g., as would be appreciated by one skilled in the art after reading the present description.

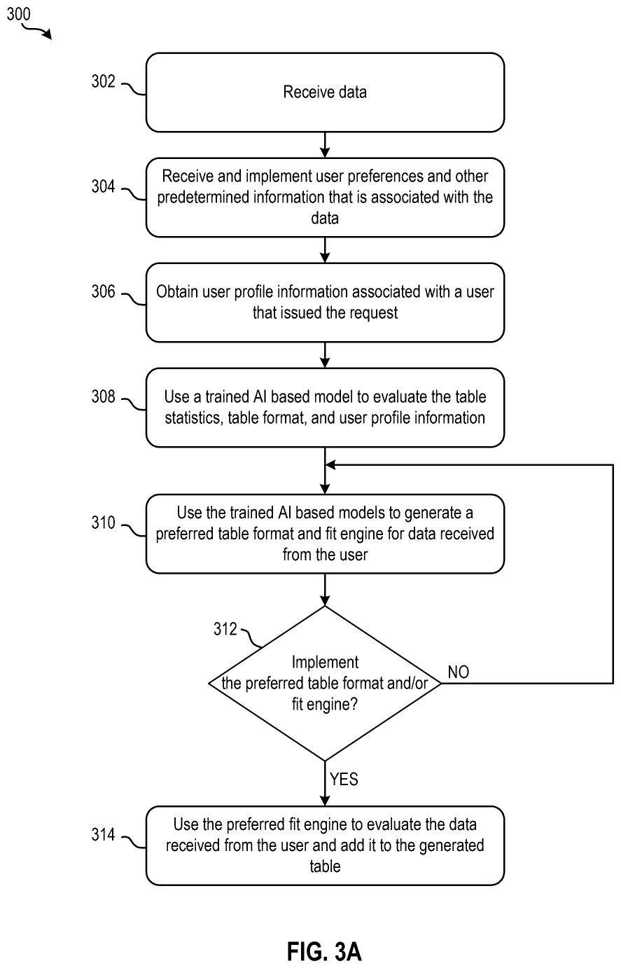

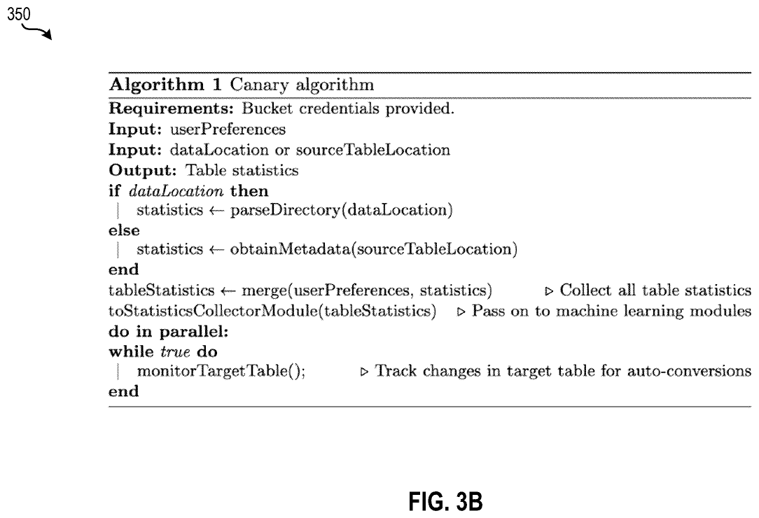

The processor 212 is also shown as including a conversion cost estimator 208 configured to evaluate the relative “cost” of converting data that is configured in a first table format, into a second table format. In other words, the conversion cost estimator 208 may be used to evaluate the content as well as formatting of data and generate an estimate of the resources that will be consumed during the process of converting the data to a different format and/or modifying content. The conversion cost estimator 208 may thereby be used to identify central (e.g., important) aspects of the data and determine how to modify these central aspects. It follows that in some approaches, conversion cost estimator 208 may be used in combination with performing one or more of the operations included in method 300 of FIG. 3A below.

With continued reference to FIG. 2A, it follows that the conversion cost estimator 208 can monitor data as it is received at the central server 202, e.g., from user device 204 and/or edge node 206. Looking to user device 204, a processor 216 coupled to memory 218 receives inputs from and interfaces with user 205. For instance, the user 205 may input information using one or more of: a display screen 224, keys of a computer keyboard 226, a computer mouse 228, a microphone 230, and a camera 232.

The processor 216 may thereby be configured to receive inputs (e.g., text, sounds, images, motion data, etc.) from any of these components as entered by the user 205.

These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using machine learning module 213. The data may be received as a result of the user 205 using one or more applications, software programs, temporary communication connections, etc. running on the user device 204. For example, the user 205 may upload data for storage at the data storage array 214 and evaluation using processor 212 and/or machine learning module 213 of central server 202. As a result, formatting details are generated and used to organize the data, and fit engines configured to efficiently access the organized data are generated. The formatting details and/or fit engines that are generated may be shared (e.g., presented) with the user 205 at the user device 204 for access, review, storage, etc. The user 205 may modify the formatting details and/or corresponding fit engines as desired before being returned to the central server 202 for implementation. As a result, clusters and corresponding tags that achieve cognitive categorization and analysis of the data originally provided by user 205 may be returned from central server 202. In some implementations, the formatting details and the fit engines configured to correspond thereto, may be evaluated further and/or used to train AI-based models and improve their ability to accurately evaluate and generate data, e.g., using one or more of the operations in method 300 of FIG. 3A, below.

Looking to the edge node 206 of FIG. 2A, some of the components included therein may be the same or similar to those included in user device 204, some of which have been given corresponding numbering. For instance, processor 217 is coupled to memory 218, a display screen 224, keys of a computer keyboard 226, and a computer mouse 228. Additionally, the processor 217 is coupled to a machine learning module 238. As described above with respect to machine learning module 213, the machine learning module 238 may include any desired number and/or type of AI-based models.

In preferred approaches, the machine learning module 238 includes AI-based models that have been trained to dynamically analyzing source data—including unstructured source data—in light of a number of different contexts (e.g., such as user preferences), and generating preferred formatting information that achieves high performance during query planning and execution in management platforms such as Lakehouse systems. The AI-based models are also preferably able to generate preferred engine configurations or “fit engines” that are able to process the source data most efficiently, based at least in part on the analyzed source data and relative context. Again, machine learning module 238 may implement any of the approaches described with respect to machine learning module 213 above.

Accordingly, the machine learning module 238 may evaluate data produced and/or stored at the edge node 206, locally analyze that data, and locally generate clusters and corresponding tags. The machine learning module 238 may thereby be able to perform substantial evaluation of sets of data without sending any information over a network. In some approaches, security measures may be lowered for prompts being processed locally by machine learning module 238 and returned directly to administrator 207. For example, certain data may be provided to machine learning module 238 and analyzed locally, while that same data may be denied from being sent to machine learning module 213 over network 210 according to compliance metrics. Additionally, because the machine learning module 238 is included at the edge node 206, responses may be generated even when the connection to network 210 is lost. In still other approaches, the machine learning module 238 may coordinate with machine learning module 213 to evaluate different sets of data received from user 205 and/or administrator 207 in parallel, e.g., as would be appreciated by one skilled in the art after reading the present description.

Referring now to FIG. 2B, a detailed overview 250 of the logical and/or physical components that may be included in and/or used by the processors (e.g., see 212, 217, etc., of FIG. 2A) and/or AI modules (e.g., see 213, 238, etc., of FIG. 2A) are illustrated in accordance with one approach, which is in no way intended to be limiting. As an option, the present overview 250 may be implemented in conjunction with features from any other embodiment listed herein, such as those described with reference to the other FIGS., such as FIG. 2A. However, such overview 250 and others presented herein may be used in various applications and/or in permutations which may or may not be specifically described in the illustrative embodiments listed herein. Further, the overview 250 presented herein may be used in any desired environment. Thus FIG. 2B (and the other FIGS.) may be deemed to include any possible permutation.

As shown, the statistics collector module 252 collects (e.g., receives, requests, extracts, exchanges for, etc.) one or more different statistics over time that correspond to a given system. For example, user preferences, table formatting statistics, query statistics, profile statistics, etc., may be collected over time. The statistics collector module 252 evaluates the received statistics and may further process the statistics. In some approaches, the statistics collector module 252 stores a copy of at least some of the received statistics in memory. The statistics collector module 252 also sends a copy of the received statistics to a conversion cost estimator 280 which may use the statistics and/or other information associated with data being evaluated to determine the amount of resources that are consumed by converting data, e.g., as will be described in further detail below.

In some approaches, the statistics collector module 252 is integrated with query execution engine. During model training and at runtime, the data collector gathers data from various data sources, e.g., as outlined in a table. The statistics collector module 252 collects user preferences, table statistics collected by canary script, table format statistics, etc. In addition, it will keep a record of average read and write operations on a table for a specified amount of time. By default, the retention time may be one month, but a user may be able to modify the retention time to up to three months. In some approaches, the average number of reads and/or writes value(s) will be used by the model training engine to predict the best fit format if auto conversion is enabled.

In response to receiving a request that is directed to the data in memory, the statistics collector module 252 sends a copy of the received statistics along with the request to a model training engine 254. There, the model training engine 254 generates, trains, maintains (e.g., re-trains), etc. AI-based models that are configured to dynamically analyzing source data—including unstructured source data—in light of a number of different contexts (e.g., such as user preferences), and generating preferred formatting information that achieves high performance during query planning and execution in management platforms such as Lakehouse systems. The AI-based models are also preferably able to generate preferred engine configurations or “fit engines” that are able to process the source data most efficiently, based at least in part on the analyzed source data and relative context.

It follows that the model training engine 254 processes the data collected by the statistics collector module 252. For instance, the model training engine 254 may validate the data and extracts model features therefrom. The extracted features may be used to train or re-train one or more AI-based models. Trained or re-trained models may thereby be verified and stored in a repository (e.g., in hardened memory).

For instance, FIG. 2B illustrates that the model training engine 254 uses the received copy of the statistics and the request to extract model features 255. These model features 255 may include any one or more of lower bounds, upper bounds, null value counts, nan value counts, value counts, column sizes, total uncompressed column sizes, verification of column existence, list of recommended split locations, partitioned specification, sort order ID, file size (e.g., in bytes), block size (e.g., in bytes), table size (e.g., in bytes), operation name, table schema ID, partition specification ID, partition field summaries, partition field values, number of data fields added, existing data file count, deleted data file count, data location, auto conversion, query engine, query cost, type, file format, CPU overhead, write intensity, read intensity, etc. The model features 255 are further used to train (e.g., create and train, re-train, etc.) one or more of the AI-based models that are in the model training engine 254. See 257. Moreover, any trained and/or re-trained models are preferably stored in memory. See 259. For example, an AI-based model repository may be established at a predetermined hardened location in memory.

With continued reference to FIG. 2B, any AI-based models that are associated with the received statistics and/or user query are preferably returned from memory to the inference engine 260 as shown. The inference engine 260 accesses the statistics collector module 252 and requests information that is associated with the received query. This information may be identified based at least in part on any features that are extracted by the model training engine 254. The inference engine 260 may thereby gain access to any desired details that have been collected.

The inference engine 260 may send one or more requests to the statistics collector module 252 to collect desired model data. The statistics collector module 252 may thereby download a prediction table format model matching the Lakehouse profile. The statistics collector module 252 may thereby generate model input vector and applies the table format prediction model. The best table format prediction is based on the predicated query cost.

It follows that the inference engine 260 evaluates the received information and generates corresponding model input vectors. See 261. These model input vectors may further be applied to one or more AI-based models which are able to generate a predicted resource cost associated with performing the received query in a number of different format configurations. See 263. As noted above, conversion costs may also be predicted and used to determine whether data referenced in received requests should be converted from a source formatting configuration to a desired target formatting.

Accordingly, the inference engine 260 and/or decision engine 270 may work in combination with the conversion cost estimator 280 to determine how a request should be satisfied. For instance, decision engine 270 is used to evaluate the relative resource costs associated with satisfying the received queries using data in different formats, and compares this to insight obtained from the conversion cost estimator 280. See 271. In some approaches the decision engine 270 analyzes inference engine output and/or user preferences, calls cost conversion estimator and maps the query cost to the table formats and/or fit engines, evaluates query cost against the cost of conversion (if conversion is needed), selects preferred query cost, and generates recommendations to the user of the preferred table format selected.

In situations where a user accepts the recommended formatting information and/or fit engines generated by the AI-based models, the conversion cost estimator 280 can actually be triggered to convert the data as outlined in the generated formatting information. A user may be able to make a decision on whether to implement based at least in part on the predicted conversion cost while considering the risks involved in the conversion process and/or the cost involved if the recommended table format is not open sourced.

The conversion process may be performed by the conversion cost estimator 280. There, the conversion cost estimator 280 converter converts the current table format to the table format predicted as the best fit table format by the decision engine 270. In response to the prediction being overridden by the user, the table format metadata converter may be used to convert the table format to an alternate option and/or using formatting information received from the user that submitted the request. Additionally, the user may enable automatic table format conversions, thereby allowing the table format metadata converter to automatically convert the table format when evolving table statistics, usage, etc., or other specifications that may be used by the decision engine 270 to predict new best fit formatting information and/or corresponding fit engines.

Outcomes of this comparison may be used by the decision engine 270 to generate a final recommendation on how the data should be formatted. Accordingly, decision engine 270 outputs data formatting to implement, along with a fit engine that is configured to access data formatted according to the recommendation more efficiently than otherwise achievable.

Looking now to FIG. 3A, a flowchart of a computer-implemented method 300 for dynamically analyzing source data in light of a number of different contexts, and generating preferred formatting information that achieves high performance during query planning and execution in management platforms such as Lakehouse systems. Method 300 is also able to generate a preferred fit engine configuration to process the source data in a most efficient manner. Method 300 may be performed in accordance with the present invention in any of the environments depicted in FIGS. 1-2B, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For example, one or more processors and/or AI modules in servers of a distributed system (e.g., see processor 212 of FIG. 2A above) may be used to perform one or more of the operations in method 300. In another example, one or more processors located at an edge server (e.g., see processors 212, 217 and/or AI modules 213, 238 of FIG. 2A above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving data to be analyzed, formatted, and accessed. In other words, the data may be received with one or more instructions (e.g., requests) to process the data. Typically, the data that is received is unstructured data. As alluded to above, one of the key advantages of unstructured data is that it helps provide qualitative information that is useful for understanding trends and changes in the data. However, the process of evaluating the unstructured data to determine these trends and changes has been taxing and caused performance setbacks in conventional products. Implementations herein are able to overcome these conventional performance issues by training one or more AI-based models to evaluate unstructured data as it is received in real-time and dynamically develop formatting details and fit engines configured to efficiently access data processed according to the formatting details.

The type, format, and/or amount of data received in operation 302 may also vary depending on the implementation. As noted above, unstructured data is an amalgamation of data typically stored in data lakes. This collection of data may include unstructured data that corresponds to various types of information, e.g., such as social media posts, video recordings, text files, audio signals (e.g., recordings), screen grab recordings, etc. In other words, the unstructured data may be collected (e.g., extracted) from different sources.

In some approaches, a statistics collector module may be integrated with a query execution engine. Moreover, during AI-based model training (and preferably during runtime), the data collector gathers data from various data sources, e.g., such as user preferences, table statistics collected by canary script, table format statistics, etc.

These statistics and an average number of reads and/or write values are automatically used by the model training engine to predict the best fit format in situations where the auto conversion is enabled.

In addition to receiving the data to be evaluated, user preferences and other predetermined information that is associated with the data may also be received and implemented. See operation 304. The predetermined information may be established using information known about unstructured data being evaluated. According to an example, which is in no way intended to be limiting, a researcher that generated a sample set of unstructured data may create predetermined information to be referenced while analyzing the data. The researcher is also able to customize details of the predetermined information based on the particular implementation. This predetermined information may thereby be created based on the testing conditions used to generate the data, the types of information included in the unstructured data, preferences of the user (e.g., a desired extraction format), etc.

The predetermined information may thereby be received from a same source as the data being evaluated. In some approaches, the predetermined information is received in parallel with the data they correspond to. In other approaches, the predetermined information may be received and incorporated into the AI-based models before the corresponding data is received and/or evaluated. Unstructured data may thereby be evaluated using AI-based models that have already been trained to identify specific information.

Additional information may also be received and used during the process of evaluating the data. In some approaches, background information corresponding to the data is received. In other words, details that describe certain characteristics of the data may be received in addition to the predetermined tags. According to another example, which again is in no way intended to limit the invention, a security plan that includes details describing how the received data was generated and secured may be obtained. In other words, information in the security plan may outline data retention objectives, access question(s), transfer methods, data collection methods, authorized users, and any other relevant information. This background information thereby provides useful insight into the received data and can be used to gain a better understanding of the received data itself.

Again, approaches herein collect a variety of statistics for query planning and optimization. These statistics include table (e.g., formatting) statistics that may be collected during loading of data into a Lakehouse instance, table statistics maintained by a table format, user preferences (e.g., as outlined in a predetermined profile), etc. For instance, profiles may be established to specify the type(s) of workloads (e.g., read and/or write), type(s) of queries, performance standards (e.g., analytics) for the type(s) of workloads, compression levels, etc. According to an example, a user profile may specify that data archival is a primary focus, thereby placing a lower priority on high throughput. These details may be used to determine query costs from improved query plans. In some approaches, a query planner and/or query optimizer may use table statistics to determine the query costs and adjust performance as such.

For instance, the resources consumed during the process of converting from one format (e.g., table configuration) to another may be weighed by one or more trained AI-based models against user preferences, resources available, query costs, etc. Based on this evaluation, AI-based models herein are able to generate a recommendation on whether the format conversion should be performed and/or alternate options that may comply with resource allocation plans, user preferences, etc. The recommendation(s) may be provided to a user, and in response to receiving any enabling responses from the user, auto-conversion of the functionality may be provided and used to convert the data, e.g., as will be described in further detail below.

With continued reference to FIG. 3A, method 300 advances from operation 304 to operation 306. There, operation 306 includes obtaining user profile information associated with a user that issued the request. In other words, operation 306 includes accessing information that outlines various details of the source (e.g., user) that issued the data and corresponding request for it to be analyzed, formatted, and accessed. The user profile information may be received along with the request in some approaches. For example, a signature associated with a user may be received along with a request in order to provide verification. In some approaches, the user profile information specifies a workload type (e.g., read, write, delete, etc.), a query type, a performance requirement, a compression level for the first user, etc. For example, performance requirements (also referred to herein as performance standards) may be determined based on industry standards, product designs, AI-based models, etc. In some approaches, a supplemental request may be sent to a source of the request initially received for details that can be used to identify the source. In some approaches, the user details are accessed from protected areas in memory.

From operation 306, method advances to operation 308. There, operation 308 includes using a trained AI-based model (e.g., a machine learning model) to evaluate the table statistics, table format, and user profile information. In other words, operation 308 includes using one or more AI-based models to evaluate the various information received in operations 302, 304, and/or 306. The AI-based models are able to provide valuable insight as to how this received information impacts how the request should be performed to achieve maximum efficiency. It follows that the AI-based models may be trained using a plurality of user preferences, table statistics and/or other statistics as training data, read and/or write data as training data, table formats associated with training data tables, etc., or any other information that provides insight into the different ways data may be stored and/or accessed depending on how it is stored in memory.

AI-based models here are also preferably re-trained using a feedback loop with read and/or write statistics used as the re-training data. For instance, AI-based models may be re-trained periodically, in response to a predetermined performance condition being met, in response to receiving instructions to do so, etc. depending on the approach. As noted above, re-training AI-based models desirably allows for the models to change over time as various constraints are updated. For example, this allows the AI-based models herein to adapt to incorporate changing system configurations, resource constraints, user preferences, performance capabilities, etc. Errors and other undesirable characteristics may thereby be identified in the data used to train the AI-based models and removed before re-training the models, thereby effectively removing the effects the flawed data has on performance of the AI-based models and tuning (improving) performance of the AI-based models. Accordingly, the re-trained AI-based models may be used to generate new preferred table formats and corresponding fit engines to use on data received from the user and/or already stored in memory. In some approaches, these updated formats and/or fit engines are presented for approval before being implemented. Thus, in response to receiving authorization, a new table designated for the first user may be generated based at least in part on the new preferred table format and new fit engine generated by the re-trained AI-based model or models.

From operation 308, method 300 advances to operation 310. There, the trained AI-based models are used to generate a preferred table format and fit engine for data received from the corresponding user. In other words, operation 310 includes using recommendations that are produced by the AI-based models in response to evaluating the table statistics, table format, user profile information, and other details to generate data formatting information and/or corresponding fit engines that are configured to achieve data access performance that is “optimum” in terms of reducing runtime by a greatest amount in comparison to any other way of satisfying received requests. Thus, approaches herein are able to reduce latency and improve throughput of the system as a whole by reducing runtime.

Moreover, operation 312 includes determining whether to actually generate (e.g., implement) a table designated for the data received from the first user based at least in part on the preferred table format and fit engine generated in operation 310 by the AI-based model(s). In other words, operation 312 includes determining whether to actually apply the recommendations that are generated by the AI-based models in operation 310 and implement the table formatting and/or fit engines determined to be a most efficient solution to the given request and/or related operations. In some approaches, operation 310 includes determining (e.g., estimating) whether a resource cost associated with converting the existing table format to the preferred table format is in a predetermined range. The range may be predetermined by a user, based on previous performance, etc. Moreover, the range may correspond to an amount of time, compute throughput, power consumption, thermal capacity, etc., associated with implementing the conversion and/or using the fit engine.

In some approaches, the process of determining whether recommended table formatting and/or fit engines should be implemented involves determining the relative cost (e.g., in terms of available system resources) associated with making the translation from the existing state of the data to the requested state (e.g., formatting and/or fit engine for processing). Operation 312 may involve estimating an amount of time associated with changing the existing formatting to the recommended formatting and comparing it to a predetermined range. In situations where modifying the formatting is determined as taking an undesirably long amount of time, method 300 returns to operation 310 from operation 312. Accordingly, the trained AI-based models are used to generate an alternate table format and fit engine for the data received from the user. In other words, method 300 returns to operation 310 such that the AI-based models can be re-trained and/or re-run to generate alternate table configurations and/or fit engines corresponding thereto in an attempt to improve overall performance. It follows that operations 312 and 310 may be repeated any desired number of times to achieve desired formatting information and/or fit engines, e.g., as would be appreciated by one skilled in the art after reading the present description.

Returning to operation 312, method 300 advances to operation 314 in response to determining that the formatting will not take an undesirably long amount of time to implement. There, operation 314 includes using the preferred fit engine to evaluate the data received from the user and add it to the generated table. In other words, operation 314 includes processing the received data as recommended by the AI-based models, thereby resulting in the request received in operation 302 being performed in a most efficient manner. According to one approach, a user request may involve creating and loading data in a preferred table format. In another approach, a user request may involve running a query on an existing table. In such approaches, a preferred engine (e.g., AI-based model) may or may not add evaluated data to the generated table depending on the user query (e.g. read, write, etc.).

Again, approaches herein are desirably able to dynamically analyze source data in light of a number of different contexts, and generating preferred formatting information that achieves high performance during query planning and execution in management platforms such as Lakehouse systems. Method 300 is also able to generate a preferred fit engine configuration to process the source data in a most efficient manner. This is particularly desirable for Lakehouse systems which may aim to provide open interfaces for engines to use when querying the same data. This was achieved at least in part herein by breaking down a traditional warehouse into distributed components, e.g., such as transaction manager, table metadata, and storage, while an engine can plan and execute queries on the shared data. To plan a query over a Lakehouse table an engine may thereby access table metadata (e.g., a location of the data files and table statistics). The speed at which the metadata can be retrieved and put into use governs performance of a query execution. In addition, metadata processing time heavily depends on the type of table format that was used to store the metadata.

According to a non-limiting example, some table formats involve storing metadata in a table, while some formats manifest files in a hierarchical structure. This further underscore importance of choosing a table format for high performant metadata planning over the aforementioned tables. Again, Lakehouse systems allow multiple engines to share and query the same data. However, the process of choosing desired engine configurations, much less design new ones, is complex and can be overwhelming.

Some approaches use cost-based approaches to query optimization. For instance, table statistics are employed to calculate the cost associated with each node in a query plan. The estimated cost information may further be displayed in a plan tree and used to determine the most performant join order (if any). According to a non-limiting example, collected statistics may include row count (e.g., a total number of rows in a table configuration), data size (e.g., amount of data being accessed), nulls fraction (e.g., fraction of null values in the data), distinct value count (e.g., number of different distinct values identified), low value (e.g., smallest value in a column), high value (e.g., largest value in a column), etc. Other approaches may allow users to specify various options to improve query execution performance, but also performs automatic optimizations using join strategies and runtime statistics to choose the most efficient query plan. The major features in the optimization techniques include coalescing post-shuffle partitions, converting sort-merge join to broadcast join, and skew join optimization. Approaches herein thereby provide table statistics as well as column statistics. Table configurations are thereby compared and used to determine a desired engine configuration that is able to improve query optimization.

Approaches herein are able to build (e.g., develop, train, re-train over time, etc.) AI-based models that are configured to determine most efficient table configurations and most efficient fit engine configurations, based at least in part on a user query. For instance, AI-based models herein may be trained to predict the best fit table and/or fit engine configuration information using with user preferences, table statistics collected by canary scripts, table format statistics, etc., which may change over time.

According to a non-limiting example, FIG. 3B includes pseudo code 350 for a canary algorithm that may be used in any of the approaches herein. As shown, the pseudo code 350 outlines (e.g., describes) runtime behavior of the system when presented with different scenarios, e.g., as would be appreciated by one skilled in the art after reading the present description.

Accordingly, approaches herein can use this algorithm (along with others) to train AI-based models to predict the best fit engine for a given scenario. The AI-based models may be trained with statistics provided by Lakehouse table formats and/or information that is specific to available engines, e.g., including suitable use cases, optimization techniques, query plans, query statistics, etc. Furthermore, in response to being presented with a query, the AI-based models are configured to determine (e.g., predict) and push-down query to the best-fit engine. This process of predicting the best fit table configuration for a user table is based on user input, table statistics collected during ETL of table data into the Lakehouse instance, table statistics maintained by a table format, etc. Moreover, predicting the best fit engine to process a query based on supported optimization techniques, execution plans, query performance, etc., of the engine(s). This allows for approaches herein to introduce multiengine strategy, which can achieve Lakehouse offerings that each have multiple-engines as well as optimized customer workloads to the best fit open table format. This service can be offered as a stand-alone option and/or be integrated with a Lakehouse offering.

This may further be leveraged to provide a best price and performance for existing warehouse workloads. Again, approaches use user preferences, canary script to collect table statistics, table statistics stored by table format, if the source table exists, etc., in combination with AI-based models that are configured (e.g., trained) to predict the optimum table format for user data as well as the best fit engine to work with that table format. Best fit table format as used herein may be based on user preferences defined through a profile. Moreover, each profile may specify type of workload (read/write), type of queries, performance requirements based on type of job such as analytics, and compression levels. The system will in turn present generated recommendations to the user and will continue execution as directed by the user. User can decide based on their preferred profile and predicted conversion cost while considering the risks involved in the conversion process and the cost involved if the recommended table format is not open-sourced.

Further still, the AI-based models used herein are preferably constantly being re-trained using a feedback loop, and therefore may be considered re-trained AI-based models. The models may be re-trained using the read and write statistics that may be maintained by the data collector module to predict new best-fit format for the ever-changing table. In situations where auto conversion is enabled then, the table may be converted to a newly predicted table format.

Again, approaches herein are desirably able to apply AI-based models (e.g., such as machine learning models) to predict query cost while executing certain query type in the predefined context (e.g., dataset size, constraints schema, partition specification, data collocation, etc.) by different query engines. Moreover, the AI-based models are able to predict and recommend query engines that are specifically configured to minimize query cost (e.g., access times). Approaches herein are thereby able to search system resource usage and performance using multiple query processing systems, e.g., as would be appreciated by one skilled in the art after reading the present description.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to dynamically analyzing source data-including unstructured source data-in light of a number of different contexts (e.g., such as user preferences), generate preferred formatting information that achieves high performance during query planning and execution in management platforms such as Lakehouse systems, and/or generate preferred engine configurations or “fit engines” that are able to process the source data most efficiently, based at least in part on the analyzed source data and relative context. Initial training may include reward feedback that may, in some approaches, be implemented using a feedback loop that incorporates data formatting and corresponding fit engines. Thus, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with formatting and/or specific fit engines, because the neuromyotonic AI model may not need an SME and/or iteratively applied training with reward feedback in order to accurately perform operations described herein. Instead, the neuromyotonic AI model is configured to itself make determinations described in operations herein. Weight values may, in some approaches, be used by the AI reasoning model to collect and analyze information and/or feedback potentially received from a user. Such an AI model ensures that the data is stored in a manner that allows it to be accessed (e.g., read, written to, etc.) most efficiently, where the scale of such analysis and determinations would not otherwise be feasible for a human to perform. This is because humans are not able to efficiently comprehend the detailed impact that each change to data in a large repository has on performance of a data storage system as a whole, and would otherwise incorporate processing delays and errors in the process of attempting to do so. Accordingly, management of operations described herein is not able to be achieved by human manual actions.

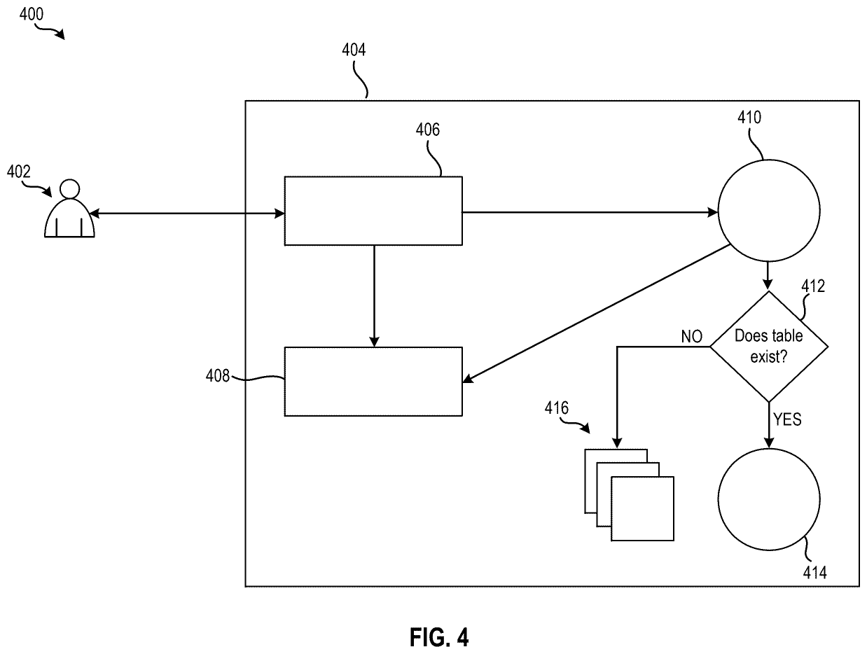

Looking now to FIG. 4, the configuration of a data management module 400 is illustrated according to an in-use example which is in no way intended to be limiting. Rather, the configuration is discussed below in the context of a number of different situations to illustrate how user requests are analyzed and processed differently.

As shown, a user 402 submits a data access request to a server 404 capable of processing the request. The request preferably includes a variety of details, e.g., such as logical and/or physical location of the requested data, size of the requested data, workload type being requested, predetermined preferences, etc. As shown the request and corresponding details are received through a user interface 406 which is displayed in response to one or more applications that are running at the server 404. The details (e.g., statistics) provided by user 402 are copied to the statistics collector module 408, e.g., for storage. Information extracted from the received request is also provided to an AI-based model 410 for evaluation. The AI-based model 410 also provides statistics and evaluation results to the statistics collector module 408.

Based at least in part on this evaluation, decision 412 determines whether the received data should be stored in an existing table format. In response to determining that the desired table format already exists, operation 414 includes obtaining metadata from existing table formatting. However, operation 416 includes accessing data files and creating the desired formatting and/or fit engine to form something new.

Here, a user can provide and/or collect information using scripts such as data location, total size, workload type, preferences (e.g., choice of query engine, preferred compression level, auto-conversion from one table format to another in future, etc.), etc. The system may kick-off a canary script to gather statistics such as size, file format, partition specification, schema, etc. The canary script may also pass this information to AI-based models (e.g., machine learning modules) which use these statistics along with the user input to predict the best fit table format as well as the best fit engine to work with that table format. Best fit table format in this context will be based on user preference defined through a profile. Each profile will specify type of workload (read/write), types of queries, performance requirements based on type of job such as analytics, and compression levels. For instance, if a user profile specifies archives, then performance will not be a higher priority. The generated recommendations will be presented to the user. User will start an ETL job for the table and specify the table format which may or may not be the system generated recommendation depending on the user's preference. The ETL job can be a separate ingest pipeline or a create a table from query results (CTAS) statement. Moreover, the ETL job will create and load data in the user table format.

In another example, a system may initiate a canary script to gather statistics using the source tables table format. The machine learning modules will use these statistics along with the user input to predict the best fit table format as well as the best fit engine to work with that table format. The generated recommendations will be presented to the user. User will start an ETL job for the table and specify the table format which may or may not be the system generated recommendation depending on the user's preference. The ETL job can be a separate ingest pipeline or a CTAS statement. The ETL job will create and load data in the user table format.

In still another example, at the time of table creation, a user may specify auto-conversion to be enabled or not. The user can change this setting at any point in time. Moreover, in response to the user submitting a query and in situations where auto conversion is enabled, the machine learning modules will use collected statistics to evaluate query cost against the cost of conversion (if conversion is selected). The generated recommendation will be presented to the user, and the table will be converted to the recommended table format in the background if a user accepts the recommendation. A user can thereby make the decision based on the predicted conversion cost while considering risks involved in the conversion process and the cost involved if the recommended table format is not open sourced.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
obtaining table statistics and a table format of a source table;
obtaining user profile information associated with a first user;
using a trained AI-based model to evaluate the table statistics, table format, and user profile information, wherein the AI-based model is trained using a plurality of user preferences, past table statistics, and table formats associated with training data tables;
using the trained AI-based model to generate a preferred table format and fit engine for data received from the first user;
generating a table for the data received from the first user based at least in part on the preferred table format and fit engine generated by the AI-based model;
collecting read and/or write statistics associated with the generated table;
extracting features from the collected read and/or write statistics; and
using the extracted features to re-train the AI-based model.

2. The method of claim 1, wherein the user profile information specifies a workload type, a query type, a performance requirement, and/or a compression level for the first user.

3. The method of claim 1, wherein the read and/or write statistics are collected using a statistics collector module.

4. The method of claim 3, wherein the features are extracted from the collected read and/or write statistics using a model training engine.

5. The method of claim 1, further comprising:
using the re-trained AI-based model to generate a new preferred table format and fit engine for data received from the user; and
generating a new table for the first user based at least in part on the new preferred table format and new fit engine generated by the AI-based model.

6. The method of claim 1, wherein the using the trained AI-based model to generate a preferred table format and fit engine for data received from the first user includes:
determining whether a resource cost associated with converting the table format to the preferred table format is in a predetermined range; and
in response to determining that the resource cost is not in the predetermined range, causing the trained AI-based model to generate an alternate table format and fit engine for the data received from the first user.

7. The method of claim 1, further comprising:
using the preferred fit engine to evaluate the data received from the first user and add it to the generated table.

8. A computer program product comprising:
one or more computer-readable storage media; and
program instructions stored on the one or more storage media to perform operations comprising:
obtaining table statistics and a table format of a source table;
obtaining user profile information associated with a first user;
using a trained AI-based model to evaluate the table statistics, table format, and user profile information, wherein the AI-based model is trained using a plurality of user preferences, past table statistics, and table formats associated with training data tables;
using the trained AI-based model to generate a preferred table format and fit engine for data received from the first user;
generating a table for the data received from the first user based at least in part on the preferred table format and fit engine generated by the AI-based model;
collecting read and/or write statistics associated with the generated table;
extracting features from the collected read and/or write statistics; and
using the extracted features to re-train the AI-based model.

9. The computer program product of claim 8, wherein the user profile information specifies a workload type, a query type, a performance requirement, and/or a compression level for the first user.

10. The computer program product of claim 8, wherein the read and/or write statistics are collected using a statistics collector module.

11. The computer program product of claim 10, wherein:
the features are extracted from the collected read and/or write statistics using a model training engine.

12. The computer program product of claim 8, wherein the operations further comprise:
using the re-trained AI-based model to generate a new preferred table format and fit engine for data received from the user; and
generating a new table for the first user based at least in part on the new preferred table format and new fit engine generated by the AI-based model.

13. The computer program product of claim 8, wherein the using the trained AI-based model to generate a preferred table format and fit engine for data received from the first user includes:
determining whether a resource cost associated with converting the table format to the preferred table format is in a predetermined range; and
in response to determining that the resource cost is not in the predetermined range, causing the trained AI-based model to generate an alternate table format and fit engine for the data received from the first user.

14. The computer program product of claim 8, wherein the operations further comprise:
using the preferred fit engine to evaluate the data received from the first user and add it to the generated table.

15. A computer system comprising:
a processor set;
one or more computer-readable storage media; and
program instructions stored on the one or more storage media to cause the processor set to perform operations comprising:
obtaining table statistics and a table format of a source table;
obtaining user profile information associated with a first user;
using a trained AI-based model to evaluate the table statistics, table format, and user profile information, wherein the AI-based model is trained using a plurality of user preferences, past table statistics, and table formats associated with training data tables;
using the trained AI-based model to generate a preferred table format and fit engine for data received from the first user; and
generating a table for the data received from the first user based at least in part on the preferred table format and fit engine generated by the AI-based model;
collecting read and/or write statistics associated with the generated table;
extracting features from the collected read and/or write statistics; and
using the extracted features to re-train the AI-based model.

16. The computer system of claim 15, wherein the user profile information specifies a workload type, a query type, a performance requirement, and/or a compression level for the first user.

17. The computer system of claim 15, wherein the read and/or write statistics are collected using a statistics collector module, wherein the features are extracted from the collected read and/or write statistics using a model training engine.

18. The computer system of claim 17, wherein the operations further comprise:
using the re-trained AI-based model to generate a new preferred table format and fit engine for data received from the user; and
generating a new table for the first user based at least in part on the new preferred table format and new fit engine generated by the AI-based model.

19. The computer system of claim 15, wherein the using the trained AI-based model to generate a preferred table format and fit engine for data received from the first user includes:
determining whether a resource cost associated with converting the table format to the preferred table format is in a predetermined range; and
in response to determining that the resource cost is not in the predetermined range, causing the trained AI-based model to generate an alternate table format and fit engine for the data received from the first user.

20. The computer system of claim 15, wherein the operations further comprise:
using the preferred fit engine to evaluate the data received from the first user and add it to the generated table.
